(19) United States
(12) Patent Application Publication
(10) Pub. No.: US 2002/0101425 A1
(43) Pub. Date: Aug. 1, 2002

(54) System, method and article of manufacture for increased I/O capabilities in a graphics processing framework

(76) Inventor: Hammad Hamid, Berkshire (GB)

Correspondence Address: CARLTON FIELDS, PA, P.O. BOX 3239, TAMPA, FL, 33601-3239, US

(21) Appl. No.: 09/772,540

(22) Filed: Jan. 29, 2001

(51) Int. Cl. G06T 1/00; G06T 15/00; G06F 15/00; G09G 5/36

(52) U.S. Cl. 345/522; 345/558

(57) ABSTRACT

A system, method and article of manufacture are provided for affording enhanced I/O capabilities during use of a digital signal processor. Initially, graphics data and a command are received indicating a type of operation to be carried out on the graphics data. Next, it is determined whether the operation requires I/O capabilities. If the operation does not require I/O capabilities, the operation is executed on the graphics data utilizing a first circuit. On the other hand, if the operation requires I/O capabilities, the operation is executed on the graphics data utilizing a second circuit. In one embodiment, the second circuit includes a programmable gate array.

### FIELD OF THE INVENTION

The present invention relates to graphics processing systems and more particularly to I/O capabilities of graphics processing systems.

### BACKGROUND 0F THE INVENTION

Rendering and displaying three-dimensional graphics typically involves many calculations and computations. For example, to render a three dimensional object, a set of coordinate points or vertices that define the object to be rendered must be formed. Vertices can be joined to form polygons that define the surface of the object to be rendered and displayed. Once the vertices that define an object are formed, the vertices must be transformed from an object or model frame of reference to a world frame of reference and finally to two-dimensional coordinates that can be displayed on a flat display device. Along the way, vertices may be rotated, scaled, eliminated or clipped because they fall outside the viewable area, lit by various lighting schemes, colorized, and so forth. Thus the process of rendering and displaying a three-dimensional object can be computationally intensive and may involve a large number of vertices.

A general system that implements a graphics pipeline system is illustrated in Prior Art FIG. 1. In this system, data source 10 generates a stream of expanded vertices defining primitives. These vertices are passed one at a time, through pipelined graphic system 12 via vertex memory 13 for storage purposes. Once the expanded vertices are received from the vertex memory 13 into the pipelined graphic system 12, the vertices are transformed and lit by a transformation module 14 and a lighting module 16, respectively, and further clipped and set-up for rendering by a rasterizer 18, thus generating rendered primitives that are stored in a frame buffer and then displayed on display device 20.

During operation, the transform module 14 may be used to perform scaling, rotation, and projection of a set of three dimensional vertices from their local or model coordinates to the two dimensional window that will be used to display the rendered object. The lighting module 16 sets the color and appearance of a vertex based on various lighting schemes, light locations, ambient light levels, materials, and so forth. The rasterization module 18 rasterizes or renders vertices that have previously been transformed and/or lit. The rasterization module 18 renders the object to a rendering target which can be a display device or intermediate hardware or software structure that in turn moves the rendered data to a display device.

Traditionally, each of the foregoing components is implemented using application specific integrated circuits. While such implementations afford increased speed, the integrated circuits must still multi-task by performing numerous different computations utilizing the same hardware. This may lead to slower processing rates, especially when handling I/O.

### SUMMARY OF THE INVENTION

A system, method and article of manufacture are provided for affording enhanced I/O capabilities during use of a digital signal processor. Initially, graphics data and a command are received indicating a type of operation to be carried out on the graphics data. Next, it is determined whether the operation requires I/O capabilities. If the operation does not require I/O capabilities, the operation is executed on the graphics data utilizing a first circuit. On the other hand, if the operation requires I/O capabilities, the operation is executed on the graphics data utilizing a second circuit. In one embodiment, the second circuit includes a programmable gate array.

### BRIEF DESCRIPTION OF THE DRAWINGS

The invention will be better understood when consideration is given to the following detailed description thereof Such description makes reference to the annexed drawings wherein:

FIG. 1 illustrates a prior art graphics pipeline;

FIG. 1A is a schematic diagram of a hardware implementation of one embodiment of the present invention;

FIG. 2 illustrates a modified graphics pipeline, in accordance with one embodiment of the present invention;

FIG. 3 illustrates a method for accelerating graphics operations during use of a digital signal processor;

FIG. 4 illustrates another method by which the modified graphics pipeline of FIG. 2 improves graphics processing;

FIG. 5 illustrates the code associated with the synchronization pulse generator of the second circuit to illustrate the simplicity of I/O management using Handel-C and FPGAs; and

FIG. 6 illustrates the details of the core loop associated with the span rendering module of the second circuit.

### DETAILED DESCRIPTION OF THE PREFERRED EMBODIMENTS

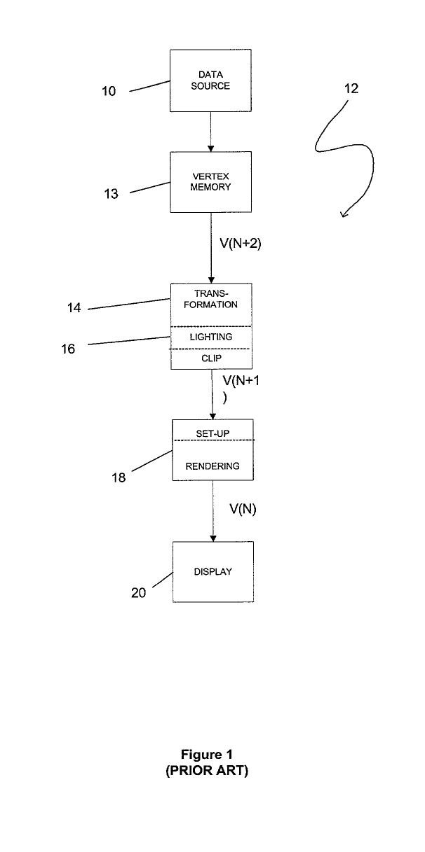

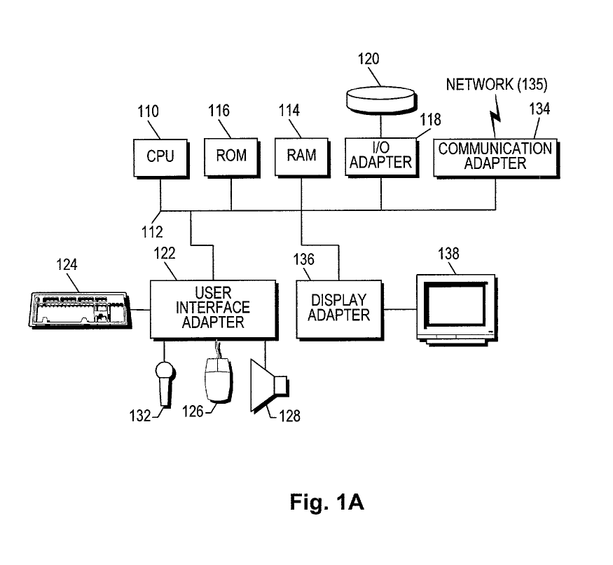

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1A, which illustrates a typical hardware configuration of a workstation in accordance with a preferred embodiment having a central processing unit 110, such as a microprocessor, and a number of other units interconnected via a system bus 112. The workstation shown in FIG. 1A includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

Resident on the workstation is a graphics pipeline similar to that shown in FIG. 1. It should be noted that such graphics pipeline may vary per the desires of the user. The present invention enhances such graphics pipeline for the purpose of further accelerating graphics processing during use.

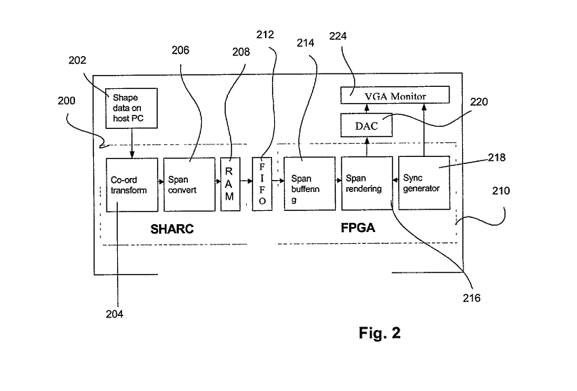

FIG. 2 illustrates a modified graphics pipeline, in accordance with one embodiment of the present invention. As shown, the pipeline includes a first circuit 200 that receives graphics data 202. Such first circuit 200 includes a transform module 204, a span converter module 206, and random access memory (RAM) 208. The operation of such modules will be set forth hereinafter in greater detail. In one embodiment, the first circuit 200 includes an Alex Computer Systems Inc APAC509 SHARCPAC module. It should be noted, however, that other digital signal processors may be utilized per the desires of the user.

Coupled to the first circuit 200 is a second circuit 210 with a first-in first-out (FIFO) buffer 212 therebetween. The second circuit 210 includes a span buffering module 214, a span rendering module 216, and a synchronization generator 218. The operation of such modules will be set forth hereinafter in greater detail. The second circuit 210 feeds output to a digital to analog converter (DAC) 220 which in turn drives a monitor 222.

In operation, the second circuit 210 offloads the first circuit 200 and the rest of the graphics pipeline in a manner that will soon be set forth for the purpose of accelerating graphics processing. In one embodiment, the second circuit 210 includes a field programmable gate array (FPGA) device. Use of such device provides flexibility in functionality, while maintaining high processing speeds.

Examples of such FPGA devices include the XC2000™ and XC3000™ families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGA's of any type may be employed in the context of the present invention.

An FPGA device can be characterized as an integrated circuit that has four major features as follows.

(1) A user-accessible, configuration-defining memory means, such as SRAM, PROM, EPROM, EEPROM, anti-fused, fused, or other, is provided in the FPGA device so as to be at least once-programmable by device users for defining user-provided configuration instructions. Static Random Access Memory or SRAM is of course, a form of reprogrammable memory that can be differently programmed many times. Electrically Erasable and reProgrammable ROM or EEPROM is an example of nonvolatile reprogrammable memory. The configuration-defining memory of an FPGA device can be formed of mixture of different kinds of memory elements if desired (e.g., SRAM and EEPROM) although this is not a popular approach.

(2) Input/Output Blocks (IOB's) are provided for interconnecting other internal circuit components of the FPGA device with external circuitry. The IOB's′ may have fixed configurations or they may be configurable in accordance with user-provided configuration instructions stored in the configuration-defining memory means.

(3) Configurable Logic Blocks (CLB's) are provided for carrying out user-programmed logic functions as defined by user-provided configuration instructions stored in the configuration-defining memory means.

Typically, each of the many CLB's of an FPGA has at least one lookup table (LUT) that is user-configurable to define any desired truth table,—to the extent allowed by the address space of the LUT. Each CLB may have other resources such as LUT input signal pre-processing resources and LUT output signal post-processing resources. Although the term ‘CLB’ was adopted by early pioneers of FPGA technology, it is not uncommon to see other names being given to the repeated portion of the FPGA that carries out user-programmed logic functions. The term, ‘LAB’ is used for example in U.S. Pat. No. 5,260,611 to refer to a repeated unit having a 4-input LUT.

(4) An interconnect network is provided for carrying signal traffic within the FPGA device between various CLB's and/or between various IOB's and/or between various IOB's and CLB's. At least part of the interconnect network is typically configurable so as to allow for programmably-defined routing of signals between various CLB's and/or IOB's in accordance with user-defined routing instructions stored in the configuration-defining memory means.

In some instances, FPGA devices may additionally include embedded volatile memory for serving as scratchpad memory for the CLB's or as FIFO or LIFO circuitry. The embedded volatile memory may be fairly sizable and can have 1 million or more storage bits in addition to the storage bits of the device's configuration memory.

Modern FPGA's tend to be fairly complex. They typically offer a large spectrum of user-configurable options with respect to how each of many CLB's should be configured, how each of many interconnect resources should be configured, and/or how each of many IOB's should be configured. This means that there can be thousands or millions of configurable bits that may need to be individually set or cleared during configuration of each FPGA device.

Rather than determining with pencil and paper how each of the configurable resources of an FPGA device should be programmed, it is common practice to employ a computer and appropriate FPGA-configuring software to automatically generate the configuration instruction signals that will be supplied to, and that will ultimately cause an unprogrammed FPGA to implement a specific design. (The configuration instruction signals may also define an initial state for the implemented design, that is, initial set and reset states for embedded flip flops and/or embedded scratchpad memory cells.)

The number of logic bits that are used for defining the configuration instructions of a given FPGA device tends to be fairly large (e.g., 1 Megabits or more) and usually grows with the size and complexity of the target FPGA. Time spent in loading configuration instructions and verifying that the instructions have been correctly loaded can become significant, particularly when such loading is carried out in the field.

For many reasons, it is often desirable to have in-system reprogramming capabilities so that reconfiguration of FPGA's can be carried out in the field.

FPGA devices that have configuration memories of the reprogrammable kind are, at least in theory, ‘in-system programmable’ (ISP). This means no more than that a possibility exists for changing the configuration instructions within the FPGA device while the FPGA device is ‘in-system’ because the configuration memory is inherently reprogrammable. The term, ‘in-system’ as used herein indicates that the FPGA device remains connected to an application-specific printed circuit board or to another form of end-use system during reprogramming. The end-use system is of course, one which contains the FPGA device and for which the FPGA device is to be at least once configured to operate within in accordance with predefined, end-use or ‘in the field’ application specifications.

The possibility of reconfiguring such inherently reprogrammable FPGA's does not mean that configuration changes can always be made with any end-use system. Nor does it mean that, where in-system reprogramming is possible, that reconfiguration of the FPGA can be made in timely fashion or convenient fashion from the perspective of the end-use system or its users. (Users of the end-use system can be located either locally or remotely relative to the end-use system.)

Although there may be many instances in which it is desirable to alter a pre-existing configuration of an ‘in the field’ FPGA (with the alteration commands coming either from a remote site or from the local site of the FPGA), there are certain practical considerations that may make such in-system reprogrammability of FPGA's more difficult than first apparent (that is, when conventional techniques for FPGA reconfiguration are followed).

A popular class of FPGA integrated circuits (IC's) relies on volatile memory technologies such as SRAM (static random access memory) for implementing on-chip configuration memory cells. The popularity of such volatile memory technologies is owed primarily to the inherent reprogrammability of the memory over a device lifetime that can include an essentially unlimited number of reprogramming cycles.

There is a price to be paid for these advantageous features, however. The price is the inherent volatility of the configuration data as stored in the FPGA device. Each time power to the FPGA device is shut off, the volatile configuration memory cells lose their configuration data. Other events may also cause corruption or loss of data from volatile memory cells within the FPGA device.

Some form of configuration restoration means is needed to restore the lost data when power is shut off and then re-applied to the FPGA or when another like event calls for configuration restoration (e.g., corruption of state data within scratchpad memory).

The configuration restoration means can take many forms. If the FPGA device resides in a relatively large system that has a magnetic or optical or opto-magnetic form of nonvolatile memory (e.g., a hard magnetic disk)—and the latency of powering up such a optical/magnetic device and/or of loading configuration instructions from such an optical/magnetic form of nonvolatile memory can be tolerated—then the optical/magnetic memory device can be used as a nonvolatile configuration restoration means that redundantly stores the configuration data and is used to reload the same into the system's FPGA device(s) during power-up operations (and/or other restoration cycles).

On the other hand, if the FPGA device(s) resides in a relatively small system that does not have such optical/magnetic devices, and/or if the latency of loading configuration memory data from such an optical/magnetic device is not tolerable, then a smaller and/or faster configuration restoration means may be called for.

Many end-use systems such as cable-TV set tops, satellite receiver boxes, and communications switching boxes are constrained by prespecified design limitations on physical size and/or power-up timing and/or security provisions and/or other provisions such that they cannot rely on magnetic or optical technologies (or on network/satellite downloads) for performing configuration restoration. Their designs instead call for a relatively small and fast acting, non-volatile memory device (such as a securely-packaged EPROM IC), for performing the configuration restoration function. The small/fast device is expected to satisfy application-specific criteria such as: (1) being securely retained within the end-use system; (2) being able to store FPGA configuration data during prolonged power outage periods; and (3) being able to quickly and automatically re-load the configuration instructions back into the volatile configuration memory (SRAM) of the FPGA device each time power is turned back on or another event calls for configuration restoration.

The term ‘CROP device’ will be used herein to refer in a general way to this form of compact, nonvolatile, and fast-acting device that performs ‘Configuration-Restoring On Power-up’ services for an associated FPGA device.

Unlike its supported, volatilely reprogrammable FPGA device, the corresponding CROP device is not volatile, and it is generally not ‘in-system programmable’. Instead, the CROP device is generally of a completely nonprogrammable type such as exemplified by mask-programmed ROM IC's or by once-only programmable, fuse-based PROM IC's. Examples of such CROP devices include a product family that the Xilinx company provides under the designation ‘Serial Configuration PROMs’ and under the trade name, XC1700D. TM. These serial CROP devices employ one-time programmable PROM (Programmable Read Only Memory) cells for storing configuration instructions in nonvolatile fashion.

A preferred embodiment is written using Handel-C. Handel-C is a programming language marketed by Celoxica Limited. Handel-C is a programming language that enables a software or hardware engineer to target directly FPGAs (Field Programmable Gate Arrays) in a similar fashion to classical microprocessor cross-compiler development tools, without recourse to a Hardware Description Language. Thereby allowing the designer to directly realize the raw real-time computing capability of the FPGA.

Handel-C is designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a net list which can be placed and routed on a real FPGA.

More information regarding the Handel-C programming language may be found in “EMBEDDED SOLUTIONS Handel-C Language Reference Manual: Version 3,” “EMBEDDED SOLUTIONS Handel-C User Manual: Version 3.0,” “EMBEDDED SOLUTIONS Handel-C Interfacing to other language code blocks: Version 3.0,” and “EMBEDDED SOLUTIONS Handel-C Preprocessor Reference Manual: Version 2.1,” each authored by Rachel Ganz, and published by Embedded Solutions Limited, and which are each incorporated herein by reference in their entirety. Additional information may be found in a co-pending application entitled “SYSTEM, METHOD AND ARTICLE OF MANUFACTURE FOR INTERFACE CONSTRUCTS IN A PROGRAMMING LANGUAGE CAPABLE OF PROGRAMMING HARDWARE ARCHITECTURES” which was filed under attorney docket number EMB1P041, and which is incorporated herein by reference in its entirety.

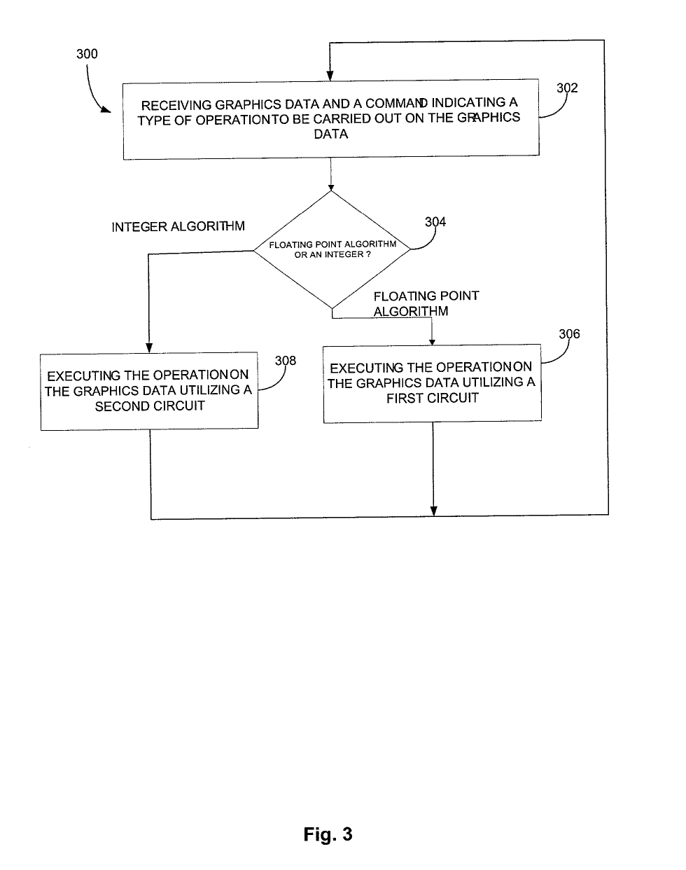

FIG. 3 illustrates a method 300 for accelerating graphics operations during use of a digital signal processor. Initially, graphics data and a command are received indicating a type of operation to be carried out on the graphics data. Note operation 302.

Thereafter, it is determined in decision 304 as to whether the operation is a floating point algorithm or an integer algorithm. As an option, the floating point algorithm may include the calculation of three-dimensional coordinates. Moreover, the integer algorithm may include a rendering algorithm, the generation of synchronization pulses, and/or the generation of a video output signal.

If the operation is the floating point algorithm, the operation is executed on the graphics data utilizing the first circuit 200, as indicated in operation 306. On the other hand, if it is decided in decision 304 that the operation is the integer algorithm, the operation on the graphics data is executed utilizing the second circuit 210. Note operation 308. As mentioned earlier, the second circuit 210 includes a programmable gate array.

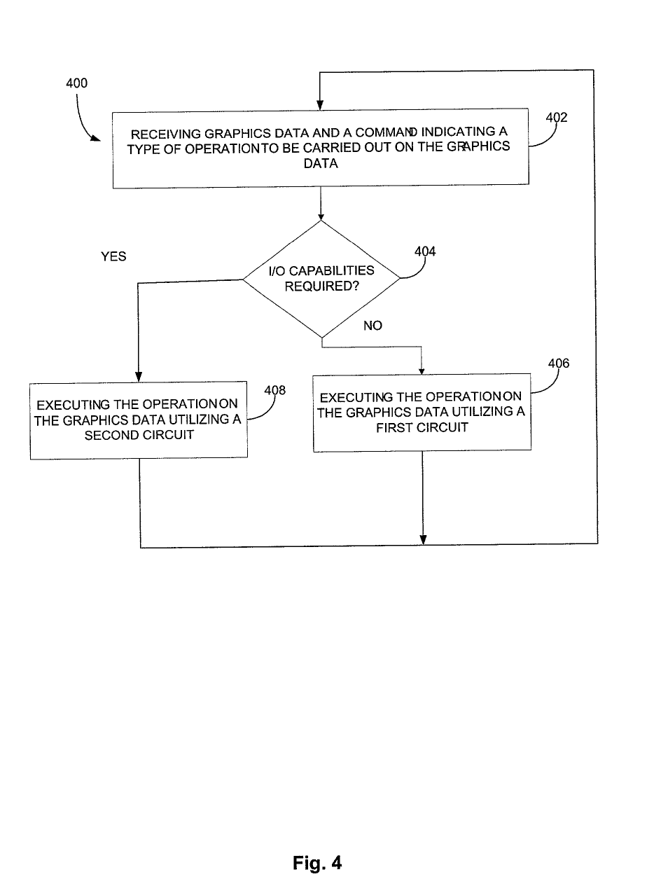

FIG. 4 illustrates another method 400 by which the modified graphics pipeline of FIG. 2 improves graphics processing. In particular, the present method 400 provides enhanced I/O capabilities during graphics processing. Initially, in operation 402, graphics data and a command is received indicating a type of operation to be carried out on the graphics data.

Next, it is determined whether the operation requires I/O capabilities in decision 404. If it is determined that the operation does not require I/O capabilities in decision 404, the operation is executed on the graphics data utilizing the first circuit 200. Note operation 406. On the other hand, if it is determined that the operation requires I/O capabilities in decision 404, the operation is executed on the graphics data utilizing the second circuit 210. Again, the second circuit includes a programmable gate array.

The present invention thus provides an enhanced real-time graphics rendering and display system for three-dimensional scenes. Such an application is an ideal example of where FPGAs can help out conventional DSPs since there are sections which require both intensive floating point and fast fixed point operations.

The conventional DSP (in one embodiment a SHARC processor) is ideally suited to floating point, irregular algorithms such as the calculation of 3D coordinates of solid objects. FPGAs on the other hand are suited to narrow width data paths in integer, regular algorithms such as rendering of two technologies pixels. Thus, the work can be split between the two technologies exploiting the strengths of each within the same application.

With their I/O flexibility, FPGAs are also ideally suited to providing interaction with the outside world which is not provided directly by a specific module. This can be usefull either because no module exists which can handle the required I/O format or to reduce the hardware required by combining multiple I/O formats into one FPGA. The I/O capabilities of the FPGA on a graphics system such as the APAC509 may be illustrated by generating the VGA signals for the graphics display directly from the pins of the FPGA. All that is required externally is a simple DAC consisting of an R-2R resistor ladder to drive the analogue RGB signals of the monitor.

The processing associated with various modules of the first and second circuit 200 and 210, respectively, of FIG. 2 will now be set forth in greater detail.

DSP Processing (First Circuit 200)

The data 202 consisting of vertices and faces is taken from a host PC hard disk or any other similar source using standard APEX parallel development environment I/O functions from Alex Computer Systems, Inc. It should be understood that other functions may be employed in other types of environments.

The first circuit 200 then makes coordinate transformations and projects the 3D points into 2D space using the coordinate transform module 204. Simple light shading is also performed at this point by calculating the intensity at each vertex given by a single point light source and a fixed ambient light.

The span converter module 206 of the first circuit 200 then generates a list of depth sorted single line spans consisting of a horizontal starting point, a starting color and a color gradient which are then packed into the on-chip RAM 208 on the first circuit 200.

Simultaneously, a looped, chain DMA is used to fill the FIFO 212 between the first circuit 200 and the second circuit 210 from an on-chip span data buffer. The DMA sequencer hardware of the first circuit 200 is used to ensure that the FIFO 212 never overflows or becomes empty.

FPGA Processing (Second Circuit 210)

The Handel-C program on the second circuit 210 (FPGA) consists of a number of parallel tasks. This illustrates the major advantage of using FPGAs for processing hardware is inherently parallel.

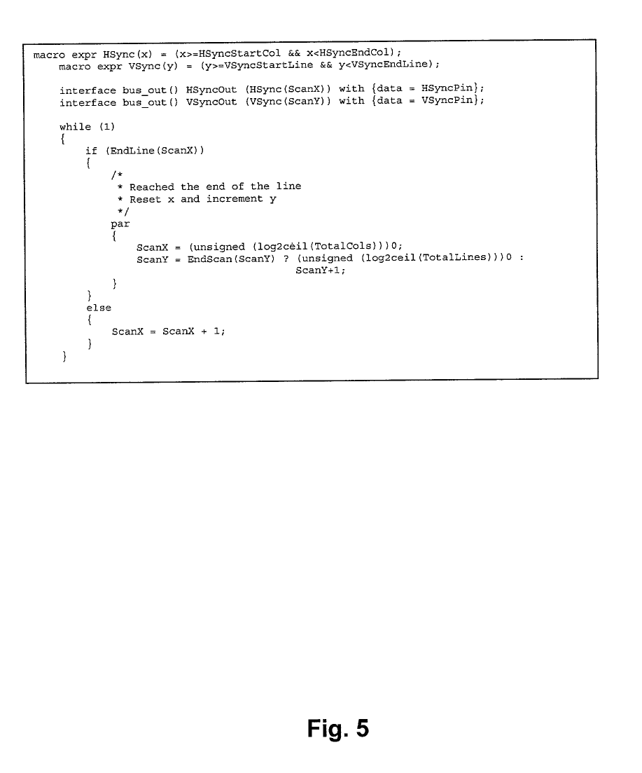

One task is used to generate the VGA sync pulses using synchronization pulse generator 218 of the second circuit 210. This task consists of two counters—ScanX and ScanY—and some comparisons to generate pulses at the correct period. FIG. 5 illustrates the code associated with the synchronization pulse generator 218 of the second circuit 210 to illustrate the simplicity of I/O management using Handel-C and FPGAs.

A second task is used to read span data from the first circuit 200 via the FIFO 212. This operation is performed during the video horizontal blanking period so that it does not disturb the video generation task. One scan line of spans is buffered during one scan line of blanking utilizing the span buffering module 214 of the second circuit 210.

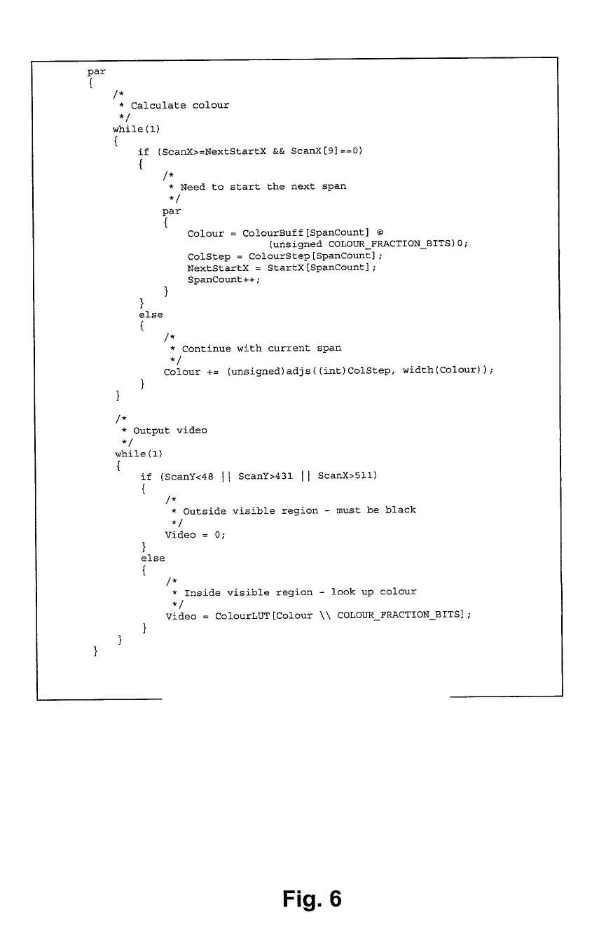

A third task generates the 18 bit per pixel video output signal by reading the buffered spans and setting the value on 18 FPGA pins to the correct color for the current pixel using the ScanX and ScanY counters from the sync generator task. FIG. 6 illustrates the details of the core loop associated with the span rendering module 216 of the second circuit 210.

To provide a comparison for performance measurement, the span rendering module 216 of the second circuit 210 has also been implemented on a single SHARC DSP using the host PC screen to display the results. Performance improvements depend on the shape being rendered but over a selection of 5 shapes the FPGA gives an approximate speed increase of 2.5 times. Coupled with this is the absence of specific video hardware or video frame buffer which translates into lower component count and system cost.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for providing enhanced I/O capabilities during use of a graphics processor, comprising the steps of:
(a) receiving graphics data and a command indicating a type of operation to be carried out on the graphics data;
(b) determining whether the operation requires I/O capabilities;
(c) executing the operation on the graphics data utilizing a first circuit if the operation does not require I/O capabilities; and
(d) executing the operation on the graphics data utilizing a second circuit if the operation requires I/O capabilities;
(e) wherein the second circuit includes a programmable gate array.

2. A method as recited in claim 1, wherein the first circuit includes a digital signal processor.

3. A method as recited in claim 1, wherein the programmable gate array is programmed using Handel-C.

4. A method as recited in claim 1, wherein the first circuit is coupled to the second circuit with a first-in-first-out (FIFO) buffer coupled therebetween.

5. A method as recited in claim 1, wherein the programmable gate array is capable of handling multiple I/O formats.

6. A method as recited in claim 1, wherein the programmable gate array is coupled to a digital-to-analog converter.

7. A computer program product for providing enhanced I/O capabilities during use of a graphics processor, comprising:
(a) computer code for receiving graphics data and a command indicating a type of operation to be carried out on the graphics data;
(b) computer code for determining whether the operation requires I/O capabilities;
(c) computer code for executing the operation on the graphics data utilizing a first circuit if the operation does not require I/O capabilities; and
(d) computer code for executing the operation on the graphics data utilizing a second circuit if the operation requires I/O capabilities;
(e) wherein the second circuit includes a programmable gate array.

8. A computer program product as recited in claim 7, wherein the first circuit includes a digital signal processor.

9. A computer program product as recited in claim 7, wherein the programmable gate array is programmed using Handel-C.

10. A computer program product as recited in claim 7, wherein the first circuit is coupled to the second circuit with a first-in-first-out (FIFO) buffer coupled therebetween.

11. A computer program product as recited in claim 7, wherein the programmable gate array is capable of handling multiple I/O formats.

12. A computer program product as recited in claim 7, wherein the programmable gate array is coupled to a digital-to-analog converter.

13. A system for providing enhanced I/O capabilities during use of a graphics processor, comprising:
(a) logic for receiving graphics data and a command indicating a type of operation to be carried out on the graphics data;
(b) logic for determining whether the operation requires I/O capabilities;
(c) logic for executing the operation on the graphics data utilizing a first circuit if the operation does not require I/O capabilities; and
(d) logic for executing the operation on the graphics data utilizing a second circuit if the operation requires I/O capabilities;
(e) wherein the second circuit includes a programmable gate array.

14. A system as recited in claim 13, wherein the first circuit includes a digital signal processor.

15. A system as recited in claim 13, wherein the programmable gate array is programmed using Handel-C.

16. A system as recited in claim 13, wherein the first circuit is coupled to the second circuit with a first-in-first-out (FIFO) buffer coupled therebetween.

17. A system as recited in claim 13, wherein the programmable gate array is capable of handling multiple I/O formats.

18. A system as recited in claim 13, wherein the programmable gate array is coupled to a digital-to-analog converter.
